(19) United States
(12) Patent Application Publication
(10) Pub. No.: US 2019/0379999 A1
(43) Pub. Date: Dec. 12, 2019

(54) TIME-BASED VERIFICATION FOR DETERMINING PRESENCE OF DEVICES AND/OR INDIVIDUALS AT SPECIFIC LOCATIONS

(71) Applicant: FUJITSU LIMITED, Kawasaki-shi (JP)

(72) Inventor: Kevin C. KREJCI, San Francisco, CA (US)

(73) Assignee: FUJITSU LIMITED, Kawasaki-shi (JP)

(21) Appl. No.: 16/001,863

(22) Filed: Jun. 6, 2018

(51) Int. Cl. H04W 4/021; H04L 9/32

(52) U.S. Cl. CPC H04W 4/021; G06Q 30/0645; H04L 9/3231

(57) ABSTRACT

Time-based verification system for determining presence of individuals at specific locations. A method may include determining a presence of a computing device associated with an individual at a location during a first time period; obtaining identification data of the individual; determining an identification of the individual based on obtaining the identification data and the presence of the computing device; verifying the individual is expected at the location based on determining the identification of the individual; and performing a secure action based on verifying that the individual is expected at the location.

### FIELD

The embodiments discussed in the present disclosure are related to time-based verification for determining the presence of devices and/or individuals at specific locations.

### BACKGROUND

An individual may be required to be in a specific location for a specific period of time (or a specific number of occasions) for many reasons, including to meet contractual or legal obligations, obtain legal benefits, meet residency requirements, satisfy rental/homesharing laws and rules, or demonstrate a minimum presence at a job. For example, recently passed legislation, as well as potential future legislation, look towards regulating the amount of time property owners may have “hosted” or “non-hosted” guests.

As another example, under recently passed legislation, an individual or family may be required to establish a minimum period of residency in a neighborhood, city, or state, in order to benefit from local and/or federal residency laws. In another example, laws or regulations may only allow a homeowner to rent out his or her primary residence for short-term periods. In an opposing example, laws or regulations may require that a homeowner rent out a property for longer periods of time, restricting short-term or night-to-night rentals. In addition, many home sharing companies are required to provide accurate information relating to the presence of guests and/or tenants in their property.

The subject matter claimed in the present disclosure is not limited to embodiments that solve a particular disadvantage or that operate only in environments such as those described above; rather, this background is only provided to illustrate one example technology area where some embodiments described in the present disclosure may be practiced.

### SUMMARY

According to an aspect of an embodiment, a method may include determining a presence of a computing device associated with an individual at a location during a first time period; obtaining identification data of the individual; determining an identification of the individual based on obtaining the identification data and the presence of the computing device; verifying the individual is expected at the location based on determining the identification of the individual; and performing a secure action based on verifying that the individual is expected at the location. The objects and advantages of the embodiments will be realized and achieved at least by the elements, features, and combinations particularly pointed out in the claims.

Both the foregoing general description and the following detailed description are given as examples and are explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 illustrates an example communications network related to a time-based location verification system, in accordance with at least some embodiments;

FIG. 2 illustrates a block diagram of a device related to a time-based location verification system, in accordance with at least some embodiments;

FIG. 3 is a flowchart of an example method related to a time-based location verification system, in accordance with at least some embodiments;

FIG. 4 is a flowchart of an example method related to a time-based location verification system, in accordance with at least some embodiments;

FIG. 5 illustrates a method of a time-based location verification system, in accordance with at least some embodiments; and

FIG. 6 illustrates a system for a time-based location verification system, in accordance with at least some embodiments.

### DESCRIPTION OF EMBODIMENTS

Some embodiments described in the present disclosure relate to methods and systems of time-based verification for determining the presence of individuals at specification locations. In some examples, individuals may have an obligation (contractual, legal, regulatory, personal, etc.) to be in a specific place at a specific time, for a specific amount of time, and/or for a specific number of times over a pre-determined time period (e.g., a number of hours per weekday, hours per month, days per month, weeks per year, etc.); however, it may be difficult to verify whether a specified individual is the individual located at an identified location, and may also be difficult to confirm and verify the frequency and length for which an identified individual is present. Furthermore, privacy issues may arise when sharing the identity and location of an individual with third parties.

The desire to track an individual at a location over a time period may arise in many situations including, but not limited to, tracking the presence of individuals in short-term rentals (e. g., homesharing), determining residency for residential benefits, and determining working and on-site hours for independent contractors or employees. Currently, legislation is often drafted too broadly or too narrowly as there are difficulties with accurately verifying the presence of a specifically identified individual at a location.

For example, short-term rental revenue may be more lucrative than long-term revenue, prompting individuals to list multiple properties for homesharing or short-term rentals, or in other examples, may encourage residents and homeowners to move to another city and rent out property for short-term use full time. Legislation has been drafted and proposed which may attempt to limit or discourage replacing long-term housing and permanent residents with short-term rentals. Thus, regulations and laws may require a host (e.g., homeowner) to be living in, or otherwise present on, his or her property a specific number of days per year, hours per day, or other measures of time to legally be eligible to rent to guests on a short-term basis. Similarly, regulations and laws may require a guest of a property to not exceed a pre-determined number of hours, days, weeks, months, etc., so as to maintain a short-term guest status and not a resident status. It may be difficult, however, to differentiate between a permanent resident and a short-term renter in order to determine whether or not the rules are being met for short-term rentals.

Furthermore, regulations and laws may require the presence of an individual and/or family in a specific location for a pre-determined period of time in order to receive local government benefits or to establish residency for public school attendance. In yet another example, companies may require employees and/or independent contractors to be present at a specific location for a specific period of time.

Thus, a check-in system which enables individuals to verify their identity and presence, while protecting their privacy, is provided herein. Embodiments of the present disclosure are explained with reference to the accompanying drawings.

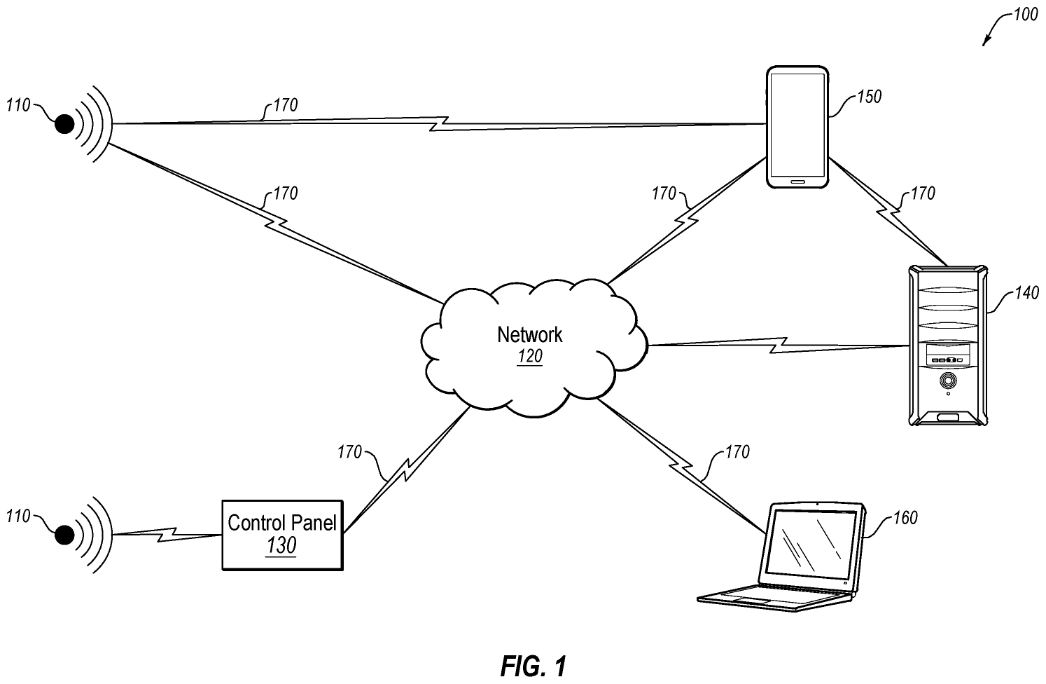

FIG. 1 illustrates a diagram representing an example communications system 100 related to a time-based verification system for determining the presence of individuals at specific locations in accordance with at least one embodiment described in the present disclosure. The communications network may include one or more sensor units 110, network 120, control panel 130, server 140, remote computing device 160, and/or local computing device 150. The network 120 may communicate by way of wired or wireless communication links 170 with sensor units 110, local computing device 150, remote computing device 160, and server 140. The control panel 130 may interface with the network 120 through wired and/or wireless communication links 170 to communicate with one or more remote servers (e.g., server 140). The control panel 130 may perform communication configuration, adjustment, and/or scheduling for communication with the computing devices 150 and 160, or may operate under the control of a controller. Control panel 130 may communicate with a back end server (e.g., server 140)—directly and/or indirectly—using at least one of the communication links 170.

The control panel 130 may wirelessly communicate with the local and/or remote computing devices by way of one or more antennas. The control panel 130 may provide communication coverage for a respective geographic coverage area (not specifically illustrated in FIG. 1). In some examples, control panel 130 may be referred to as a control device, a base transceiver station, a radio base station, an access point, a radio transceiver, or some other suitable terminology. The geographic coverage area for control panel 130 may be divided into sectors making up only a portion of the full coverage area. The communications system 100 may include control panels of different types. There may be overlapping geographic coverage areas for one or more different parameters, including different technologies, features, subscriber and/or user preferences, laws, regulations, hardware, software, technology, and/or methods. For example, each control panel may be related to one or more discrete structures (e.g., a home, a business, etc.) and each of the one or more discrete structures may be related to one or more discrete areas (e. g., a neighborhood, a city, a state, etc.). In other examples, multiple control panels may be related to the same one or more discrete structures (e.g., multiple control panels associated with a single home and/or business complex).

The computing devices 150 and 160 may be dispersed throughout the communications system 100 and each device 150 and 160, respectively, may be stationary and/or mobile. Computing devices 150 and 160 may include, but are not limited to, a cellular phone, a tablet computer, a wearable electronic device (e.g., a smart watch, a biometric sensor and/or tracker), a personal digital assistant (PDA), a wireless modem, a handheld device, a laptop computer, a cordless phone, a wireless local loop (WLL) station, a display device (e.g., a television set, a computer monitor, etc.), a printer, a camera, or any combination of the above. Computing devices 150 and 160 may also include or be referred to by those skilled in the art as a user device, a user equipment, a smartphone, a BLUETOOTH® device, a Wi-Fi device, a mobile station, a subscriber station, a remote unit, a handset, a user agent, a mobile client, a client, and/or some other suitable terminology.

The geographic coverage area for the control panel 130 may be divided into sectors making up only a portion of the coverage area. The communication system, therefore, may include more than one control panel 130, where each control panel 130 may provide geographic coverage for a sector of the coverage area.

The communication system may include one or more control panels 130 of different types; for example, control panel 130 may be a local computing device and/or a computing interface located at a home and/or business. Control panel 130 may be in direct communication by way of wired or wireless communication links with the one or more sensor units 110. In another embodiment, control panel 130 may receive sensor data from the one or more sensor units 110 by way of computing devices 150, 160, server 140, and network 120.

In one embodiment, the control panel 130 may include, or otherwise be coupled to/in communication with, a speaker, a microphone, and/or a camera. The control panel 130 may operate to broadcast audio and/or video communications from devices 150 and/or 160. In other embodiments, control panel 130 may receive input in the form of audio input, video input, biometric data, geographic data (e.g., geotagging, global positioning data), regulatory data, and the like.

The control panel 130 may wirelessly communicate with the sensor units 110 via one or more antennas. The sensor units 110 may be dispersed throughout the communications system 100 and each sensor 110 may be stationary and/or mobile. A sensor 110 may include and/or be one or more sensors that sense: proximity, motion, temperatures, humidity, vibration, sound level, smoke, structural features (e.g., glass breaking, window position, door position), time, amount of light, geo-location data of a user and/or a device, distance, biometrics, weight, speed, height, size, gait, preferences, weather, system performance, respiration, heartbeat, and/or other inputs that relate to time-based verification of determining the presence of a specific individual at a specific location.

In some embodiments, sensor units 110 may be, but are not limited to, a temperature sensor, proximity sensor, motion sensor, accelerometer, gyroscope, infrared (IR sensor), pressure sensor, ultrasonic sensor, smoke detector, a biometric sensor (e.g., fingerprint reader, palm reader, iris and/or retinal scanner, voice print sensor, heart rate detector, etc.), a GPS detector, a wireless receiver, and the like. In some cases, any of sensor unit 110 may be a standalone sensor coupled, wired or wirelessly, to a computing device and/or other receiver. In the case that the sensor unit 110 is a standalone sensor, the sensor unit 110 may be mounted at a location with which an individual may be enabled to interact with the sensor unit 110. For example, a biometric scanner may be mounted at a doorway, where the individual may interact with the scanner to provide an example palm print or retinal scan. In additional or alternative embodiments, sensor 110 may be or be collocated with a mobile phone, table, wearable device, or any other portable or mobile device.

Computing devices 150 and/or 160 and/or at least one sensor 110 may be able to communicate through one or more wired and/or wireless connections with various components such as control panels, antennas, base stations, and/or network equipment (e.g., servers, wireless communication points, etc.).

The communication links 170 illustrated in communications system 100 may include uplink (UL) transmissions from devices 150 and 160 and/or sensor units 110 to control panel 130, and/or downlink (DL) transmissions, from control panel 130 to devices 150 and/or 160. The downlink transmissions may also be called forward link transmissions while the uplink transmissions may also be called reverse link transmissions. Each communication link 170 may include one or more carriers, where each carrier may be a signal made up of multiple sub-carriers (e.g., waveform signals of different frequencies) modulated according to the various radio technologies. Each modulated signal may be sent on a different sub-carrier and may carry control information (e.g., reference signals, control channels, etc.), overhead information, user data, etc. The communications links 170 may transmit bidirectional communications and/or unidirectional communications, including, but not limited to 345 MHz, Wi-Fi, BLUETOOTH®, BLUETOOTH® Low Energy, cellular, Z-WAVE®, millimeter wave, 802.11, peer-to-peer (P2P), LAN, WLAN, Ethernet, firewire, fiber optic, and/or other connection types.

In some embodiments, control panel 130 and/or computing devices 150 and/or 160 may include one or more antennas configured to employ antenna diversity schemes to improve communication quality and reliability between the control panel and the computing devices. Additionally or alternatively, control panel 130 and/or devices 150 and 160 may employ multiple-input, multiple-output (MIMO) techniques that may take advantage of multi-path, mesh-type environments to transmit multiple spatial layers carrying the same or different coded data.

While the computing devices 150 and/or 160 may communicate with each other through the control panel 130 using communication links 170, each device 150 and/or 160 may communicate with one or more other devices by way of one or more direct communications links 170. Two or more devices 150 and 160 may communicate via a direct communication link 170 when both devices 150 and 160 are in the geographic coverage area or when one or neither of the devices 150 or 160 is within the geographic coverage area. Examples of direct communication links 170 may include Wi-Fi Direct, BLUETOOH®, wired, and/or other P2P group connections. The computing devices 150 and 160 in these examples may communicate according to the Wide Local Area Network (WLAN) radio and baseband protocol including physical and Media Access Control (MAC) layers from the Institute of Electrical and Electronics Engineers (IEEE) standards, such as 802.11, and its various versions including, but not limited to: 801.11a, 802.11b, 802.11g, 802.11n, 802.11ac, 802.11ad, and 802.11ah. In other implementations, other P2P connections and/or ad hoc networks may be implemented within communications system 100.

In some examples, local computing device 150 may be a custom computing entity configured to interact with sensor units 110 via network 120 and/or server 140. In other examples, local computing device 150 may be a general purpose computing entity such as a personal computing device; for example, local computing device 150 may be a desktop computer, a laptop computer, a netbook, a tablet personal computer (PC), a control panel, an indicator panel, a multi-site dashboard, an IPOD®, a smartphone, a cellular phone, a PDA, and/or any other suitable device operable to send and receive signals, store and retrieve data, and/or execute software components.

The computing devices 150 and 160 may include memory, a processor, an output, a data input, and a communications component. The processor may be, but is not limited to, a general purpose processor, a Field Programmable Gate Array (FPGA), an Application Specific Integrated Circuit (ASIC), a Digital Signal Processor (DSP), etc. The processor may be configured to retrieve data from and/or write data to the memory.

The memory may be, but is not limited to, a random access memory (RAM), a memory buffer, a hard drive, a database, an erasable programmable read only memory (EPROM), an electrically erasable programmable read only memory (EEPROM), a read only memory (ROM), a flash memory, a hard disk, a floppy disk, or cloud storage. In some embodiments, the computing devices 150 and 160 may include one or more hardware-based modules (e.g., FPGA, ASIC, DSP, etc.) and/or software-based modules (e.g., a module of computer code stored at the memory and executed at the processor, a set of processor-readable instructions that may be stored at the memory and executed at the processor) associated with executing an application, such as, for example, receiving, analyzing, transmitting, and/or displaying data from the sensor units.

The processor of the local computing device 150 may be operable to control operation of the output of the local computing device 150. The output may be a television, a liquid crystal display (LCD) monitor, a cathode ray tube (CRT) monitor, plasma monitor, speaker, tactile output devices (e.g., a capacitive touchscreen device), smart speaker, hearable devices, holograms, etc. In some embodiments, the output may be an integral component of the local computing devices 150; for example, the output may be directly coupled to the processor. In some embodiments, an output component may include, but is not limited to, a High Definition Multimedia Interface™ (HDMI) connector, a Video Graphics Array (VGA) connector, a Universal Serial Bus™ (USB) connector, a tip, ring, sleeve (TRS) connectors, and/or any other suitable connector operable to couple the local computing device 150 to the output.

The remote computing device 160 may be a computing entity operable to enable a remote user to monitor the output of the sensor units 110 and/or the local computing device 150. The remote computing device 160 may be functionally and/or structurally similar to the local computing device 150 and may be operable to receive data streams from and/or send signals to at least one of the sensor units 110 via the network 120. The network 120 may be the Internet, an intranet, a personal area network PAN, a local area network (LAN), a wide area network (WAN), a virtual network, a telecommunications network implemented as a wired network and/or wireless network, etc. The remote computing devices 160 may receive and/or send signals over the network 120 by way of communication links 170 and server 140.

In some embodiments, one or more sensor units 110 may communicate through wired and/or wireless communication links 170 with one or more of the computing devices 150 and 160, the control panel 130, and the network 120. The network 120 may communicate through wired and/or wireless communication links 170 with the control panel 130, and the computing devices 150 and 160 through server 140. In another embodiment, the network 120 may be integrated with any of the computing devices 150 and 160 and/or server 140 such that separate components are not required. Additionally, in another embodiment, one or more sensor units 110 may be integrated with control panel 130, and/or control panel 130 may be integrated with the location computing device 150 such that separate components may not be needed.

In some embodiments, the one or more sensor units may be sensors configured to conduct periodic or ongoing automatic measurements related to determining the identity of a user (e.g., a homeowner, a renter, a lessee, an employee. etc.), as well as determining the location of a user within a pre-determined location, and/or the amount of time spent in an identified location. Each sensor unit 110 may be enabled to sense multiple identifications, location-determining, and/or time-determining parameters, or alternatively, separate sensor units 110 may monitor separate identification and/or location determining parameters. For example, one sensor unit may receive data used to determine the identity of an individual, whereas a second sensor unit may receive data used to determine the location of the individual.

In some embodiments, a local computing device 150 may additionally monitor alternate location-determination parameters, such as detecting a heartbeat, breathing, motion, heat signatures, and/or audio. In alternative embodiments, an individual may input identification and/or location information directly at the local computing device 150 or a control panel 130. The identification and/or location data may be communicated to the remote computing devices 160 for verification. In some embodiments, the identification and/or location data communicated to the local and/or remote computing devices 150 and 160 may be encrypted. In addition, a GPS feature integrated with an individual's local computing device 150 may communicate the user's location to the remote computing device 160.

In some embodiments, the one or more sensor units 110 may be separate from the control panel 130 and may be positioned at various locations throughout a property (e.g., a house, an apartment, a room, an office building, outside of a building, etc.). In other embodiments, the one or more sensor units 110 may be integrated or collocated with other building automation system components, home appliances, building fixtures, and the like; for example, a sensor unit 110 may be integrated into a front door monitoring system, a light fixture, a wall outlet or switch, a home or office automation digital interface, etc. In any embodiment, each of the one or more sensor units 110, control panel 130 and/or local computing device 150 may include a speaker unit, a microphone unit, and/or a camera unit.

The server 140 may be configured to communicate with the one or more sensor units, local computing device 150, remote computing device 160, and the control panel 130. The server may perform additional processing on signals received from the one or more sensor units 110, local computing device 150, or control panel 130, and may forward the received information to the remote computing device 160.

Server 140 may be a computing device operable to receive data streams, store, and/or process data, and/or transmit data and/or data summaries and analysis. The server 140 may include a database (e.g., in memory) containing location, identification, time, and/or authentication data received from the sensor units 110 and/or the local computing device 150 and/or the control panel 130. Additionally, software (e.g., stored in memory) may be executed on a processor of the server 140.

Modifications, additions, or omissions may be made to FIG. 1 without departing from the scope of the present disclosure. For example, the communications system 100 may include more or fewer elements than those illustrated and described in the present disclosure. In addition, in some embodiments, sensor units 110, control panel 130, local and/or remote computing devices 150 and 160, respectively, and/or server 140 may be combined such that they may be considered the same device.

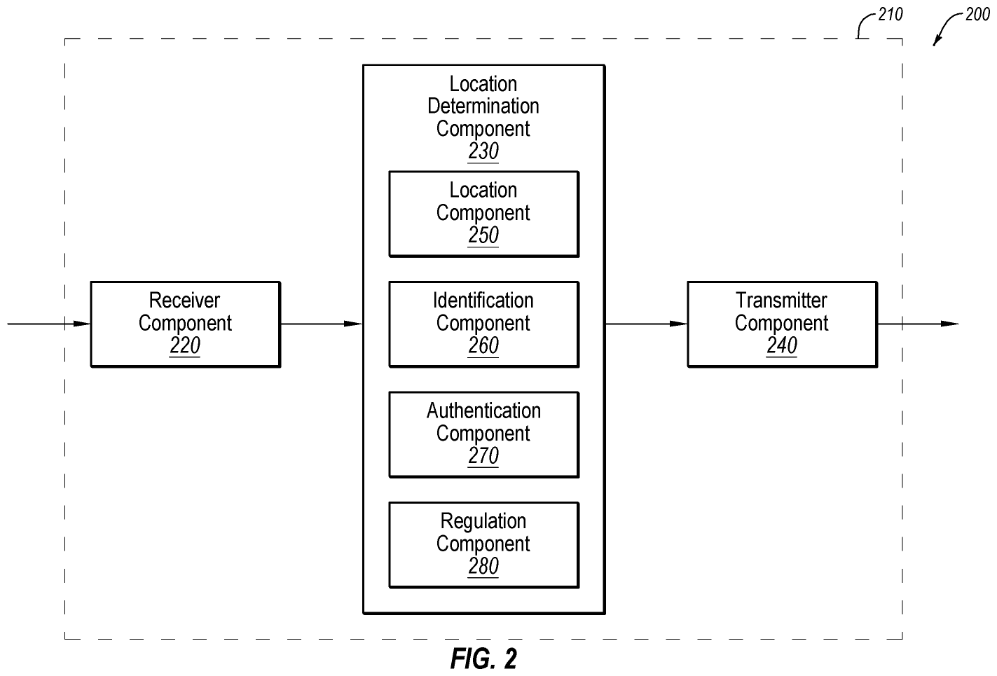

FIG. 2 illustrates a block diagram of an apparatus 210 for use in electronic communication in accordance with various aspects of this disclosure. The apparatus 210 may be an example of one or more aspects of control panel 130 and/or local computing device 150 and/or remote computing device 160 and/or sensor units 110. The apparatus 210 may include a receiver component 220, a location determination component 230, and/or a transmitter component 240. The apparatus 210 may also be or include a processor. Each of these components may be in communication with one another—directly and/or indirectly.

The components of the apparatus 210 may, individually or collectively, be implemented using one or more application specific integrated circuits (ASICs) adapted to perform some or all of the applicable functions in hardware. Alternatively, the functions may be performed by one or more other processing units or cores, on one or more integrated circuits. In other examples, other types of integrated circuits may be used (e.g., Structure/Platform ASICs, Field Programmable Gate Arrays (FPGAs), and other Semi-Custom ICs), which may be programmed in any manner known in the art. The functions of each component may also be implemented—in whole or in part—with instructions embodied in memory formatted to be executed by one or more general and/or application-specific processors.

The receiver component 220 may receive information such as packets, user data, and/or control information associated with various information channels (e.g., control channels, data channels, etc.). The receiver component 220 may be configured to receive data, audio and/or video streams from the remote computing device 160, which may be operated by a third party. Received data, audio and/or video streams may be passed onto a location determination component 230. In addition, the location determination component 230 may detect data, audio, video, identification, location, time, and/or authentication information at the apparatus 210 and may communicate the detected data to a transmitter component 240, and/or to other components of the apparatus 210 not specifically illustrated in FIG. 2.

Where apparatus 210 is any of a sensor unit, control panel, or local computing device, receiver component 220 may be operable to receive audio, and/or video broadcasts from the remote computing device. Such audio and/or video broadcasts may be in the form of real-time verbal and/or graphic (e.g., video or still image) communications or a transmission of a pre-recorded communication. In some embodiments, the pre-recorded communication may be created by the manufacturer (i.e., messages that are pre-programmed by the original equipment manufacturer) or may be user-provided.

The transmitter component 240 may then communicate the data to the remote computing device 160, the control panel 130, and/or the server 140. In other embodiments, a user may personally record a message that will be broadcast when certain conditions are met. In another embodiment, the audio and/or visual communication may be transmitted to a remotely located display device and/or speaker unit.

Location determination component 230 may further include any of a location component 250, an identification component 260, an authentication component 270, and/or a regulation component 280.

As discussed briefly before, individuals may have contractual or legal obligations to be present in a specific location (or a plurality of locations) for a pre-determined period of time and/or a number of discrete visits; for example, an individual may have an obligation to be at a worksite for a pre-determined number of hours per weekday, hours per week, days per week, days per year, etc. In another example, an individual may have a legal obligation to be a resident of a city to satisfy a residency obligation and receive residential benefits. In another example, a homeowner may have an obligation to be present in his or her home for a pre-determined number of days in order to qualify the home as a short-term rental versus a long-term rental.

In one embodiment, location component 250 may detect the presence of an individual at a specific location (e.g., the entrance of a home or a worksite, a specific room within a building, etc.). In one embodiment, apparatus 210 may be a computing system or sensor located at the location in question; for example, apparatus 210 may be an interactive wall panel located outside the entrance to a building, or may be an interactive wall panel located inside a building in any room. In some embodiments, apparatus 210 may not be interactive, but may rather be a passive sensor. In another embodiment apparatus 210 may be a hand-held personal computing device in the possession of an individual to be tracked, such as a smart phone, tablet device, wearable computing device, and the like.

In some embodiments, apparatus 210 may be a biometric sensor such as, but not limited to, an eye scanner, a fingerprint scanner, a palm scanner, a voiceprint sensor, a camera calibrated to identify facial structure; a GPS receiver or an input device (e.g., a keypad) into which an individual may input a personal identification number (PIN); a motion sensor; a vibration sensor; a light sensor, etc. In another embodiment, an individual may interact with a software application executing on a smart computing device to “check-in” that he or she is present at a location. Any of the aforementioned devices may be enabled to determine the presence of an individual at a location, but may not, at this stage, necessarily confirm the identification of a person. In some embodiments, GPS coordinates of a location to be monitored may be stored in memory with a third-party. The location data received by the location component 250 may be communicated to the transmitter component 240, and the transmitter component may communicate the data to the remote computing device 160 and/or server 140.

Identification component 260 may determine the specific identity of the individual. In one embodiment, identification component 260 may determine the identification of an individual by way of a biometric identification. The biometric identification may include, but is not limited to, analyzing a fingerprint, a retinal pattern, an iris recognition, facial recognition, a voice print, a palm print, and the like. Any of the biometric datum may be received at the user's computing device, such as a smartphone, either automatically (e.g., by way of a passive sensor) or actively by the user (e.g., activating a biometric scan on the user's computing device). In other embodiments, the biometric data may be received as input at a sensor 110, control panel 130, or at another local computing device 150 disposed at the location. In another embodiment, the identification component 260 may identify the individual by way of identifying the presence of the individual's electronic device (e.g., by comparing the device's current GPS data with the location data of the subject property and/or location). In other embodiments, identification component 260 may receive identification data in the form of a password, personal identification number (PIN), or other alphanumeric input. The identification data received by the identification component 260 may be communicated to the transmitter component 240, and the transmitter component may communicate the data to the remote computing device 160 and/or server 140.

In addition to the aforementioned, location component 250 and/or identification component 260, either alone or in combination, may also time stamp each time an identified individual is located in a specific location, including time stamping an entrance into a building and/or room, and time stamping an exit out of a building and/or a room. In order to determine whether an individual is entering or exiting, location component 250 may use methods to determine the presence of an individual in a location or to alternatively determine the lack of a presence of an individual in a location (and thus the departure of an individual), such as through motion sensors, microphones, cameras, vibration sensors, heat sensors, infrared sensors, NFC technology, wireless communication, etc.

Authentication component 270 may determine whether the identified individual is authorized, authenticated, and/or matches an expected individual with regard to location and time; for example, a third party such as the government, a homesharing administrator, an employer, etc., may have a list of individuals expected to be in a specific location at or for a specific length of frequency of time. Authentication component 270, thus, determines that the identified individual matches the expected individual in question.

In one embodiment, authentication component 270 may use multi-factor authentication; for example, an individual may be associated with a computing device, such as a smartphone, with the authentication component 270 included therein, and the individual may use his or her smartphone to “check-in” at the location. In one embodiment, the computing device may also include a sensor unit 110, where the computing device is enabled to receive identification information, as well as enable authentication, such as by authentication component 270. In the case where the computing device may operate as a sensor unit 110 and may also operate to authenticate the individual, the computing device may receive identification information, such as a fingerprint or a PIN. The information obtained at the computing device (operating as a sensor unit 110), may then be processed or analyzed by the processor of the computing device (e.g., implementing the authentication component 270), to authenticate that the individual inputting identification information is in fact the individual associated with the computing device.

A smartphone, however, may be carried by anyone, not just the owner; thus, the authentication component 270 may correlate the identifying information obtained from the smartphone with biometric information input. In some embodiments, the biometric information may be input at or otherwise received at the smartphone itself. In other embodiments, the location of the smartphone may be determined, such as through verified GPS coordination matching, and an individual may input biometric information into a computing device or sensor located within a pre-determined distance from the smartphone's current GPS coordinates.

In another embodiment, authentication component 270 may provide online biometric authentication such that an individual that wants to provide input to or access a device and/or server may perform a biometric scan on his or her smartphone (or other portable electronic device). Once the scan is received by a remote computing device, a confirmation of authentication may be communicated by way of a secure connection to a cloud-based server (e.g., server 140). Near Field Communication (NFC) technology, or other short-range wireless technology (LAN, Bluetooth, etc.) may be used to confirm that the individual who provided the biometric data is in proximity to the input device and/or service with which the individual is attempting to interact.

In some embodiments, a third party may maintain a database of individuals, where the database contains identifying information for authentication. For example, the database may store biometric information, gait data, passwords, PIN codes, smartphone identification data (e.g., a mobile subscription identification number (MSIN), an international mobile subscriber identity (IMSI), an electronic serial number (ESN), etc.), and the like.

In some embodiments, identification data and location data may be communicated in a secure manner. In one example, the data may be subject to encryption. Encryption methods may include, but are not limited to, checksums, cyclic redundancy checks (CRC), public key encryption (e.g., secure sockets layer (SSL), transport layer security (TLS)), hashing algorithms, advanced encryption standard (AES), block chain algorithms, etc.

Regulation component 280 may determine whether the presence of the identified and authenticated individual has satisfied a threshold duration of time at a location and/or has satisfied a threshold frequency of presence at a location. Regulation component 280 may analyze time stamps, and other location and identification data obtained by the location, identification and authentication components 250, 260, and 270, respectively, to obtain a snapshot of an individual's location. The data may be securely transferred to a third party using any of the encryption and security techniques described above.

In addition, regulation component 280 may be able to determine the location of the individual in varying locations over the course of a specific time period, including tracking the time the individual traveled from location to location. This additional data may be used to confirm or authenticate the identity and location of the individual.

In some embodiments the techniques of time-based verification for determining the presence of individuals at specific locations described herein may be a voluntary opt-in system. In other embodiments, participation in the system may be compulsory to receive benefits or to be able to participate in specific programs.

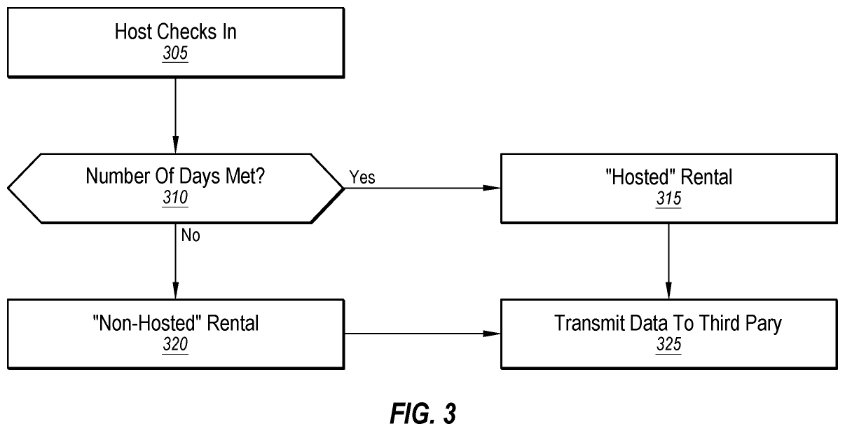

FIG. 3 illustrates a flowchart of one example embodiment in accordance with the present disclosure. The method 300 may be performed by any suitable system, apparatus, or device. Although illustrated with discrete blocks, the steps and operations associated with one or more of the blocks of the method 300 may be divided into additional blocks, combined into fewer blocks, or eliminated, depending on the particular implementation.

FIG. 3 illustrates a flowchart for determining whether an owner of a property qualifies as having guests for a “hosted” rental or a “non-hosted” rental. In some cases, a governmental entity may require a host (e.g., a property owner) to “check-in” to his or her property at least once per day to prove the owner is resident on their property for a minimum number of days a year. If the owner does not meet this threshold, the governing entity may, for example, levy fines or restrict rental opportunities.

The method 300 begins at block 305, where the host “checks-in” to his or her property at least once a day, or over a designated period of time. The check-in process may be enabled as discussed with reference to FIG. 2; namely, the owner/host may use his or her smartphone to indicate that he or she, and the smartphone, are located at the same GPS coordinates of the intended location (i.e., the owner's property). In some embodiments, the host may use his or her smartphone to check-in; whereas in other embodiments, the host may check-in at a device associated with the property itself, such as an interactive wall panel or other sensor. As described herein, the smartphone may include or operate also as a sensor unit 110, enabled to obtain location and/or identification information. A multi-factor authentication may take place which determines whether the individual who is present at the location and checked-in is in fact the owner/host. The multi-factor identification may consider multiple inputs such as biometric data, PIN codes, smartphone identification, and the like. In some embodiments, the identification data may be cross referenced with information stored in a database to determine a match. In some embodiments, a time stamp or other indicator may be made to identify the presence of the owner/host at the expected location. The steps described with reference to block 305 may be performed by location determination component 230 described with reference to FIG. 2, and more specifically, with location component 250, identification component 260, and/or authentication component 270.

At block 310, the regulation component 280 may receive or independently determine the number of check-ins made at the property by the owner/host, as opposed to by another party. The number of check-ins may be compared to a pre-determined minimum threshold needed to consider the rental a “hosted” rental versus a “non-hosted” rental. If the number of check-ins by the owner meets the threshold, then the rental is considered a “hosted” rental as illustrated in block 315. If the number of check-ins by the owner does not meet the threshold, then the rental is considered a “non-hosted” rental as illustrated in block 320.

In block 325, with either classification, the identification, authentication, and location/time data may be transmitted to a third-party for further processing, such as to a governmental entity, the owner, the renter, etc.

In another case similar to the flowchart illustrated in FIG. 3, a governmental entity may require a host to check-in at least once during a time period that a “hosted” guest is staying at the host's property. Thus, using the methods described above with respect to FIG. 3, a host may register that a guest is expected during a certain time frame (e.g., May 1 through May 10). At least once during the time period, the host should check in using a computing device. The location determination component 230 may verify the presence of the host, at the expected location, during the time period the guest is expected. If the host is verified and the check in matches the expected time frame, then the guest is classified as a “hosted” guest; in contrast, if the host is not verified and/or does not check in during the time the guest is expected, then then guest is classified as “non-hosted.”

In some cases, a host may only be allowed a certain number of hosted visits, or a certain number of days to have a “hosted” and/or “non-hosted” guest. Thus, the data may be transmitted to a third party to determine whether the host is in violation of a rule.

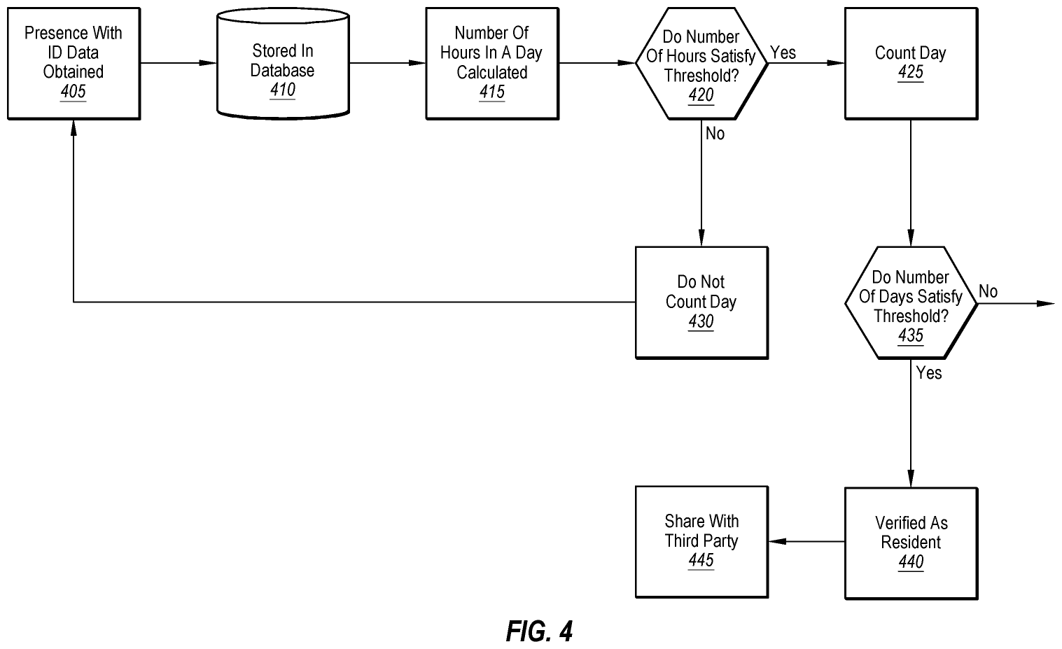

FIG. 4 illustrates a flow chart for determining whether an owner of a property is at the property enough to be considered a resident of, for example, a city. At block 405, the location determination component 230 may collect presence and identification data for an individual purporting to be a resident of a location. As described with reference to FIGS. 2 and 3, the individual may check-in at his or her home using a smartphone device associated with the individual. If the GPS coordinates of the home and the GPS coordinates of the phone match, then the individual may be determined to be located at the home. In some embodiments, the GPS coordinates may match within a pre-determined distance to reduce false-negatives with regarding to being at the location. In another embodiment, there may be a geo-fence located around a home, building, yard, room, etc., and location determination component 230 (and more specifically, location component 250), may determine the smartphone or other portable computing device has crossed into or out of the geo-fence, thus indicating the presence of the individual at the location.

In addition, the identity of the individual may be determined, and the individual authenticated as the purported resident of the location, by way of biometric identification, multi-factor authentication, or other identification and authentication methods and techniques enabled by identification and authentication components 260 and 270, respectively.

At block 410, in some embodiments, the presence and identification data may be transmitted to a database (such as a database associated with remote server 140) for storage and/or analyzing. At block 415, the number of time units, such as hours, for example, that the individual is determined to be present at the location in a designated time period, such as in a day, for example, is calculated. In order to be considered “present” for residency purposes, there may be a minimum threshold of time the individual should spend at the location; for example, it may be assumed that an individual residing at the location at least sleeps at the location, and thus should be at the location for a minimum of six hours per day. At block 415, therefore, the number of hours per day that the individual is determined to be at the location may be calculated. At block 420, the location determination component 230 (or another computing device), may determine whether the number of hours the individual is determined to be at the location satisfies the threshold. If the number of hours does not satisfy the threshold, then at block 430, the presence of the individual at the location is not considered as a “day” for residency purposes, and the steps may begin again at block 405 the next day. In contrast, if the number of hours does satisfy the threshold, then at block 425, the presence of the individual at the location is considered a “day” (the designated time period) for residency purposes.

In some embodiments, a governmental entity, for example, may establish a minimum number of days required at a location for an individual to be considered a resident. Thus, at block 435, the location determination component 230 (or another computing device) may determine if the number of aggregate days satisfies a pre-determined threshold of days. If the number of days the individual is determined to be at the location satisfies the threshold, then residency is verified (block 440). A resident may receive governmental benefits, and thus, in some embodiments, the data related to presence, identification, and amount of time the individual spends at a location may be securely transmitted to a third party for processing and further analysis (block 445).

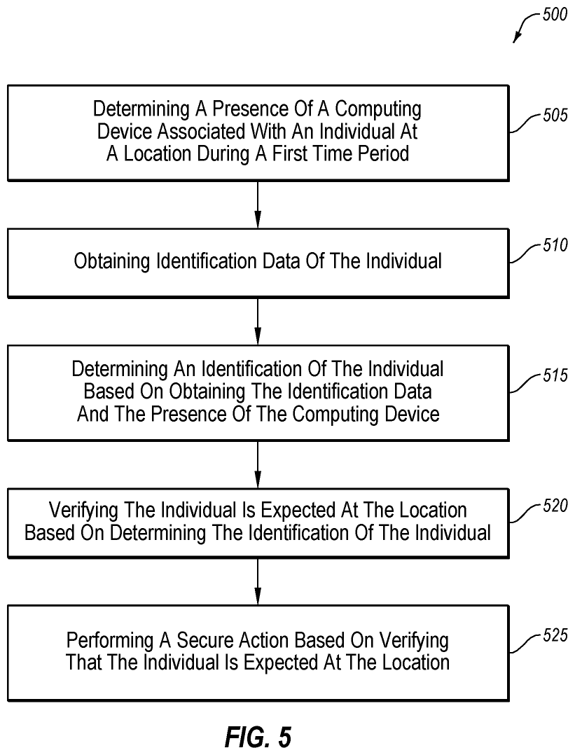

FIG. 5. illustrates a method of a time-based verification system in accordance with at least some embodiments. At block 505, the method may determine a presence of a computing device associated with an individual at a location during a first time period. In one embodiment, block 505 may be performed by location component 250 described with reference to FIG. 2.

At block 510, the method may include obtaining identification data of the individual. In one embodiment, block 510 may be performed by identification component 260.

At block 515, the method may include determining an identification of the individual based on obtaining the identification data and the presence of the computing device. In one embodiment, block 515 may be performed by identification component 260.

At block 520, the method may include verifying the individual is expected at the location based on determining the identification of the individual. In one embodiment, block 520 may be performed by authentication component 270.

At block 525, the method may include performing a secure action based on verifying that the individual is expected at the location. In one embodiment, block 525 may be performed by regulation component 280. In some embodiments, a secure action may include, but is not limited to, transmitting location data, identification data, authentication data, and related regulatory data to a third party in a secure manner, such as by encrypting the data. In some embodiments, other secure data transmission methods may be used to transmit data. In other embodiments, a secure action may include providing access to a system at a location and/or the location itself; for example, access to an entrance, access to automation features (e.g., lights, appliances, audio and/or visual communication systems), and access to security features associated with the location.

The method 500 may improve the efficiency and efficacy of a time-based verification system for determining the presence of individuals at specific locations; for example, the determining the presence of and authenticating the identification of an individual at a location over a number of iterations may help to identify an individual's whereabouts more quickly and with more accuracy.

Modifications, additions, or omissions may be made to the method 500 without departing from the scope of the present disclosure. For example, the operations of method 500 may be implemented in differing order. Additionally or alternatively, two or more operations may be performed at the same time. Furthermore, the outlined operations and actions are only provided as examples, and some of the operations and actions may be optional, combined into fewer operations and actions, or expanded into additional operations and actions without detracting from the essence of the disclosed embodiments.

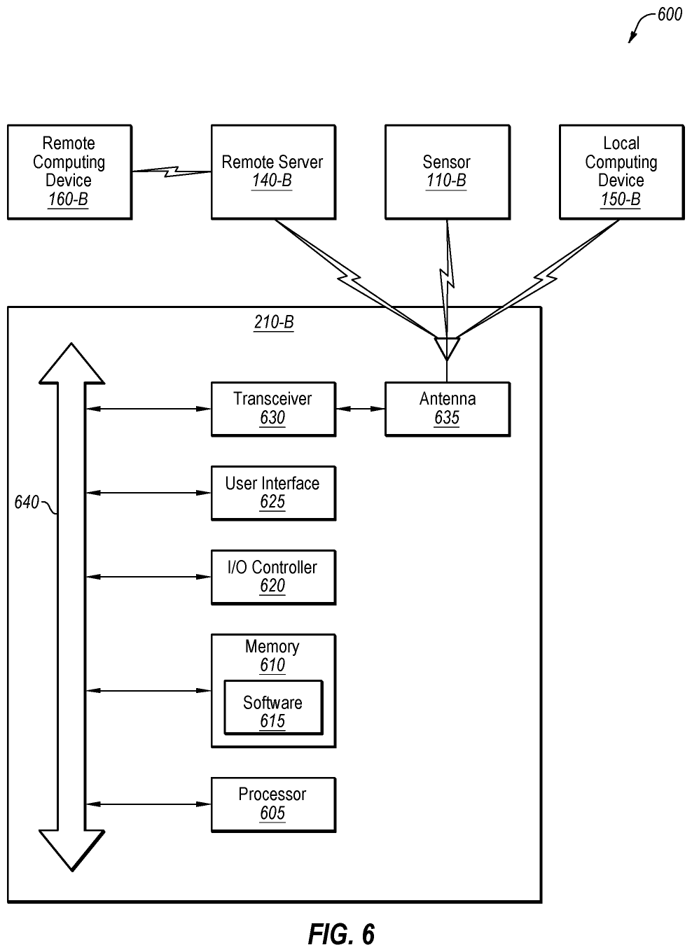

FIG. 6 illustrates a system 600 for use in time-based verification for determining the presence of individuals at specific locations in accordance with various examples. System 600 may include an apparatus 210-b, which may be an example of one or more aspects of any of a sensor 110, control panel 130, local computing device 150, and/or remote computing device 160 described with reference to FIG. 1. Apparatus 210-b may also be an example of one or more aspects of apparatus 210 described with reference to FIG. 2.

Apparatus 210-b may include components for bi-directional voice and data communications including components for transmitting communications and components for receiving communications. For example, apparatus 210-b may communicate bi-directionally with one or more of local computing device 150-b, one or more sensor units 110-b, remote computing device 160-b, and/or remote server 140-b, which may be an example of the components described with reference to FIG. 1. This bi-directional communication may be direct (e.g., apparatus 210-b communicating directly with remote computing device 160-b) or indirect (e.g., apparatus 210-b communicating indirectly with remote computing device 160-b through remote server 140-b).

Apparatus 210-b may also include a processor 605, and memory 610 (including software/firmware code (SW) 615), an input/output controller 620, a user interface 625, a transceiver 630, and one or more antennas 635 each of which may communicate—directly or indirectly—with one another (e.g., via one or more buses 640). The transceiver 630 may communicate bi-directionally—via the one or more antennas 635, wired links, and/or wireless links—with one or more networks or remote devices as described above. For example, the transceiver 630 may communicate bi-directionally with one or more of sensor units 110-b, local computing device 150-b, remote computing device 160-b, and/or remote server 140-b. The transceiver 630 may include a modem to modulate the packets and provide the modulated packets to the one or more antennas 635 for transmission, and to demodulate packets received from the one or more antennas 635. While the apparatus 210-b may include a single antenna 635, the apparatus may also have multiple antennas 635 capable of concurrently transmitting or receiving multiple wired and/or wireless transmissions. In some embodiments, one element of apparatus 210-b (e.g., one or more antennas 635, transceiver 630, etc.) may provide a direct connection to the remote server 140-b via a direct network link to the Internet via a POP (point of presence). In some embodiments, one element of apparatus 210-b (e.g., one or more antennas 635, transceiver 630, etc.) may provide a connection using wireless techniques, including digital cellular telephone connection, Cellular Digital Packet Data (CDPD) connection, digital satellite data connection, and/or another connection.

The signals associated with system 600 may include wireless communication signals such as radio frequency, electromagnetics, local area network (LAN), wide area network (WAN), virtual private network (VPN), wireless network (using 802.11, for example), 345 MHz, Z-WAVE®, cellular network (using 3G and/or LTE, for example), and/or other signals. The one or more antennas 635 and/or transceiver 630 may include or are related to, but are not limited to, WWAN (GSM, CDMA, and WCDMA), WLAN (including BLUETOOTH® and Wi-Fi), WMAN (WiMAX), antennas for mobile communications, antennas for Wireless Personal Area Network (WPAN) applications (including RFID and UWB). In some embodiments, each antenna 635 may receive signals or information specific and/or exclusive to itself. In other embodiments, each antenna 635 may receive signals or information not specific or exclusive to itself.

In some embodiments, one or more sensor units 110-b may connect to some element of system 600 via a network using one or more wired and/or wireless connections. In some embodiments, the user interface 625 may include an audio device, such as an external speaker system, an external display device such as a display screen, and/or an input device (e.g., remote control device interfaced with the user interface 625 directly and/or through input/output controller 620). One or more buses 640 may allow data communication between one or more elements of apparatus 210-b (e.g., processor 605, memory 610, input/output controller 620, user interface 625, etc.).

The memory 610 may include random access memory (RAM), read only memory (ROM), flash RAM, and/or other types. The memory 610 may store computer-readable, computer-executable software/firmware code 615 including instructions that, when executed, cause the processor 605 to perform various functions described in this disclosure (e.g., time-based verification for determining the presence of individuals at specific locations, etc.). Alternatively, the software/firmware code 615 may not be directly executable by the processor 605 but may cause a computer (e.g., when compiled and executed) to perform functions described herein. Alternatively, the computer-readable, computer-executable software/firmware code 615 may not be directly executable by the processor 605 but may be configured to cause a computer (e.g., when compiled and executed) to perform functions described herein. The processor 605 may include an intelligent hardware device, e.g., a central processing unit (CPU), a microcontroller, an application-specific integrated circuit (ASIC), etc.

In some embodiments, the memory 610 may contain, among other things, the Basic Input-Output system (BIOS) which may control basic hardware and/or software operation such as the interaction with peripheral components or devices. Applications resident with system 600 are generally stored on and accessed via a non-transitory computer readable medium, such as a hard disk drive or other storage medium. Additionally, applications may be in the form of electronic signals modulated in accordance with the application and data communication technology when accessed via a network interface (e.g., transceiver 630, one or more antennas 635, etc.).

Many other devices and/or subsystems may be connected to one or more, or may be included as one or more elements of system 600 (e.g., entertainment system, computing device, remote cameras, wireless key fob, wall mounted user interface device, cell radio module, battery, alarm siren, door lock, lighting system, thermostat, home appliance monitor, utility equipment monitor, and so on). In some embodiments, all of the elements illustrated in FIG. 6 need not be present to practice the present systems and methods. The devices and subsystems may be interconnected in different ways from that illustrated in FIG. 6. In some embodiments, an aspect of some operation of a system, such as that illustrated in FIG. 6, may be readily known in the art and are not discussed in detail in this application. Code to implement the present disclosure may be stored in a non-transitory computer-readable medium such as one or more of system memory 610 or other memory. The operating system provided on input/output controller 620 may be iOS®, ANDROID®, MS-DOS®, MS-WINDOWS®, OS/2®, UNIX®, LINUX®, or another known operating system.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated. In this description, a “computing entity” may be any computing system as previously defined in the present disclosure, or any module or combination of modulates running on a computing system.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. As an aid to understanding, the following appended claims may contain usage of the introductory phrases “at least one” and “one or more” to introduce claim recitations; however, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

1. A method comprising:
obtaining data related to a threshold time amount an individual is to be at a location during a first time period;
determining an amount of time the individual is at the location during the first time period, where determining the amount of time comprises:
determining a presence of a computing device associated with the individual at the location during the first time period, the presence including a duration of time the computing device is at the location;
obtaining identification data of the individual from a sensor at the location; and
determining an identification of the individual based on the identification data and the determined presence of the computing device at the location during the first time period;
determining that the amount of time satisfies the threshold time amount; and
in response to the amount of time satisfying the threshold time amount, performing a secure action.

2. The method of claim 1, wherein determining the presence of the computing device at the location comprises:
obtaining location coordinates of the location;
determining location coordinates of the computing device during the first time period; and
comparing the location coordinates of the location and the location coordinates of the computing device.

3. (canceled)

4. The method of claim 1, further comprising:
determining a departure of the computing device from the location;
determining the presence of the computing device during a second time period that occurs after determining the departure of the computing device; and
calculating a frequency of time periods related to the presence of the computing device at the location.

5. The method of claim 1, wherein determining the presence of the computing device at the location during the first time period further comprises:
establishing a geo-fence around the location; and
determining that the computing device has crossed over the geo-fence.

6. The method of claim 1, wherein performing the secure action further comprises:
securely transmitting data regarding the presence of the computing device and the identification of the individual to a third party.

7. (canceled)

8. The method of claim 1, wherein obtaining identification data of the individual further comprises:
receiving, at the location, biometric data associated with the individual;
receiving, at the location, a second indication of identification; and
determining that both the biometric data and the second indication of identification are associated with the individual.

9. A system, comprising:
a processor;
memory in electronic communication with the processor; and
instructions stored in the memory, the instructions being executable by the processor to cause the system to perform operations comprising:
obtaining data related to a threshold time amount an individual is to be at a location during a first time period;
determining an amount of time the individual is at the location ruing the first time period, where determining the amount of time comprises:
determining a presence of a computing device associated with the individual at the location during the first time period, the presence including a duration of time the computing device is at the location;
obtaining identification data of the individual from a sensor at the location; and
determining an identification of the individual based on the identification data and the determined presence of the computing device at the location during the first time period;
determining that the amount of time satisfies the threshold time amount and
in response to the amount of time satisfying the threshold time amount, performing a secure action.

10. The system of claim 9, wherein when the presence of the computing device is determined, the instructions are further executable by the processor to cause the system to perform operations comprising:
obtaining location coordinates of the location;
determining location coordinates of the computing device during the first time period; and
comparing the location coordinates of the location and the location coordinates of the computing device.

11. (canceled)

12. The system of claim 9, wherein the instructions are further executable by the processor to cause the system to perform operations comprising:
determining a departure of the computing device from the location;
determining the presence of the computing device during a second time period that occurs after determining the departure of the computing device; and
calculating a frequency of time periods related to the presence of the computing device at the location.

13. The system of claim 9, wherein when the presence of the computing device is determined, the instructions are further executable by the processor to cause the system to perform operations comprising:
establishing a geo-fence around the location; and
determining that the computing device has crossed over the geo-fence.

14. The system of claim 9, wherein when the secure action is performed, the instructions are further executable by the processor to cause the system to perform operations comprising:
securely transmitting data regarding the presence of the computing device and the identification of the individual to a third party.

15. (canceled)

16. The system of claim 9, wherein when identification data of the individual is obtained, the instructions are further executable by the processor to cause the system to perform operations comprising:
receiving, at the location, biometric data associated with the individual;
receiving, at the location, a second indication of identification; and
confirming both the biometric data and the second indication of identification are associated with the individual.

17. A non-transitory computer-readable medium storing computer-executable code, the code executable by a to cause the system to perform operations, the operations comprising:
obtaining data related to a threshold time amount an individual is to be at a location during a first time period;
determining an amount of time the individual is at the location during the first time period, where determining the amount of time comprises:
determining a presence of a computing device associated with the individual at the location during the first time period, the presence including a duration of time the computing device is at the location;
obtaining identification data of the individual from a sensor at the location; and
determining an identification of the individual based on the identification data and the determined presence of the computing device at the location during the first time period;
determining that the amount of time satisfies the threshold time amount; and
in response to the amount of time satisfying the threshold time amount, performing a secure action.

18. The non-transitory computer-readable medium of claim 17, wherein in response to the system determining the presence of the computing device, the operations further comprise:
obtaining location coordinates of the location;
determining location coordinates of the computing device during the first time period; and
comparing the location coordinates of the location and the location coordinates of the computing device.

19. (canceled)

20. The non-transitory computer-readable medium of claim 17, wherein in response to the system determining the presence of the computing device, the operations further comprise:
determining a departure of the computing device from the location;
determining the presence of the computing device during a second time period that occurs after determining the departure of the computing device; and
calculating a frequency of time periods related to the presence of the computing device at the location.

21. The method of claim 1, wherein obtaining data related to the threshold time amount further comprises:
identifying a minimum amount of time the individual is to be at the location during the first time period.
